(19) United States
(12) Patent Application Publication
(10) Pub. No.: US 2009/0303412 A1
(43) Pub. Date: Dec. 10, 2009

(54) ILLUMINATING DEVICE, BACKLIGHT DEVICE, LIQUID CRYSTAL DISPLAY DEVICE, METHOD FOR CONTROLLING ILLUMINATING DEVICE AND METHOD FOR CONTROLLING LIQUID CRYSTAL DISPLAY DEVICE

(76) Inventors: Yasunori Ake, Nara (JP); Kazuhiro Uehara, Nara (JP); Yasukuni Yamane, Nara (JP)

Correspondence Address: HARNESS, DICKEY & PIERCE, P.L.C., P.O. BOX 8910, RESTON, VA, 20195, US

(21) Appl. No.: 12/309,112

(22) PCT Filed: Jun. 14, 2007
(86) PCT No.: PCT/JP2007/062022

§ 371 Date: Jan. 7, 2009

(30) Foreign Application Priority Data
Sep. 6, 2006 (JP) 2006-242047

(51) Int. Cl. G02F 1/1335; H05B 37/02

(52) U.S. Cl. 349/61; 315/152

(57) ABSTRACT

An illuminating device is provided with a plurality of light source modules (LM) each of which has a light emitting element and a driver circuit for driving the light emitting element, and the illuminating device controls the driver circuit of each light source module individually. All the light. source modules are grouped by having a plurality of light source modules arranged at intervals (d) as one group. A step of lighting light emitting bodies of the light source modules in the same group (for instance, LM (1, 1)·LM (1, 9)) simultaneously under predetermined conditions is performed in turn for all the groups. Based on the obtained light emitting quantity of the light emitting element of each light source module (LM), the driver circuit of the light source module is controlled. Thus, in a backlight device provided with a plurality of illuminating areas, the light emitting quantity in each illuminating area can be accurately corrected in a short time.

### TECHNICAL FIELD

The present invention relates to an illuminating device used for a display device such as a liquid crystal display device.

### BACKGROUND ART

A conventional backlight device for a non-illuminating type display device such as a liquid crystal display device emits light with fixed brightness. The brightness of the backlight is set so that a display screen can attain maximum brightness. However, when the brightness of the backlight is fixed regardless of the displayed images, unnecessary power is consumed because the power does not contribute to display black or dark images. Moreover, some light of the backlight leaks when displaying black, and the leakage of light causes decrease of the contrast.

As is disclosed in Patent Documents 1 to 3, a display device (backlight) provided with a plurality of illuminating areas is proposed. The display device controls the brightness of each illuminating area depending on inputted image signals.

[Patent Document 1] Japanese Unexamined Patent Application Publication No. 2005-70690 (published on Mar. 17, 2005)

[Patent Document 2] Japanese Unexamined Patent Application Publication No. 2005-258403 (published on Sep. 22, 2005)

[Patent Document 3] Japanese Unexamined Patent Application Publication No. 2002-99250 (published on Apr. 5, 2002)

### DISCLOSURE OF INVENTION

However, light emitting elements are uneven in characteristic. Moreover, when a plurality of illuminating areas is controlled individually, the total quantity of light emission of each area (time-integrated value) is different. Because of this difference, the light emitting quantity in each illuminating area becomes different (even though the same control for light emitting is performed). For instance, when a different color of light emitting element is provided in each illuminating area, the same color of the light emitting bodies in each illuminating areas would emit different quantity of light. In order to solve above problem, the light emitting quantity may be corrected in each illuminating area. However, when the light emitting quantity is detected or corrected in the condition that the each illuminating area is lit, the correction accuracy cannot be improved because of the interference between illuminating areas whereas users will not notice the correction visually.

The present invention is accomplished in consideration of above problems. An object of the invention is to correct light emitting quantity in each illuminating area of a backlight device provided with a plurality of illuminating areas accurately in a short time (in such a short time that users will not notice the correction).

An illuminating device according to the present invention comprises: light source modules each includes a light emitting element and a driver circuit for driving the light emitting element, the driver circuit of each light source module is controllable individually, wherein: the light source modules are grouped into groups including a plurality of the light source modules arranged with intervals between each other; the step of turning on the each light emitting element of the light source modules in the same group simultaneously under a predetermined condition is carried out in turn for all the groups; and the driver circuit for the light source module is controlled based on a light emitting quantity thus obtained of the light emitting element of each light source module.

In accordance with the above configuration, because a plurality of light source modules are lit simultaneously and the light emitting quantity is detected thereafter, time for the detection step can be drastically reduced compared to a step of scanning light source modules (detecting light emitting quantity) one by one. Moreover, because each light source module in the same group (lit simultaneously) is arranged with intervals between each other, a crosstalk between those light source modules is reduced. As a result, the detection accuracy of light emitting quantity can be secured. The driver circuit of the light source module is controlled based on the light emitting quantity of each light source module detected in the step, and thereby the correction of light emitting quantity of each light source module can be performed accurately in a short time.

In the present illuminating device, it is preferable that each light source module includes a light sensor for detecting the light emitting quantity of the light emitting element included in the light source module. The detecting accuracy of light emitting quantity can be improved by installing a light sensor on each light source module.

In the present illuminating device, it is preferable that the intervals between each light source module are so large that the light from each light source module in the same group does not interfere the others. By doing this, a crosstalk between light source modules emitting light simultaneously can be eliminated and thereby the detecting accuracy of light emitting quantity can be improved furthermore.

In the present illuminating device, the step is performed when the light emitting element is at its service temperature (for instance, almost at the same time as a illuminating device in use is turned off).

In the present illuminating device, it is preferable that each of the light source module includes a temperature sensor and the control is performed based on the detected temperature by the sensor. The light emitting element changes its characteristic depending on its temperature. The light emitting quantity of each light source module is measured at the same time as the temperature of each light source is measured, and thereby a change quantity of light emitting quantity of light emitting element by such as secular variation in each light source module can be calculated. By controlling the driver circuit of each light source module based on the calculated change quantity of light emitting quantity, a light emitting quantity of each light source module can be corrected more accurately.

Especially, when the step is performed under the condition that the light emitting element is at service temperature, the temperatures of light emitting bodies between light source modules are different depending on the latest use situation. Even in this case, a change quantity of light emitting quantity (by such as secular variation) is calculated based on the light emitting quantity and temperature of each light source module, and thereafter the driver circuit of each light source module is controlled based on the calculation, and thereby the light emitting quantity of each light source module can be corrected more accurately.

In this case, for instance, standard light emitting quantity by certain temperature is determined in advance, and thereafter a change quantity of light emitting quantity is calculated in each of the light source module based on the measured temperature, and then the driver circuit is controlled (the light emitting quantity is corrected) based on the calculation result. In the case of a standard light emitting quantity at temperature T1 is regarded as Lx and a standard light emitting quantity at temperature T2 is regarded as Ly, if the temperature of first light source module is T1 with light emitting quantity L1, and also the temperature of second light source module is T2 with light emitting quantity L2, the driver circuit in the first light source module is controlled (light emitting quantity is corrected) based on a change quantity of light emitting quantity (L1-Lx), and also the driver circuit in the second light source module is controlled (light emitting quantity is corrected) based on a change quantity of light emitting quantity (L2-Ly).

In the present illuminating device, each light source module includes light emitting elements of plural kinds, and the same-kind light emitting elements can be lit simultaneously in each light source module in the same group.

In the present illuminating device, each light source module may include LEDs of three colors, and in each light source module, each color LED is lit in turn.

Moreover, in each of the light source module, the two colors of LEDs may be lit simultaneously, and the rest color of the LED is lit thereafter. In this case, each light source module includes the red LED, green LED and blue LED. The red and blue LEDs, those two have separate peak wavelength one another, are lit simultaneously, and the green LED is lit thereafter. By doing this, the detection time can be reduced furthermore.

Moreover, the present illuminating device may be arranged such that the driver circuit of each light source module is controlled based on the light emitting quantity of the light emitting element of the light source module, so as to adjust a driving current value or driving frequency of the light emitting element.

A backlight device according to the present invention comprises the illuminating device described above.

Moreover, a liquid crystal display device according to the present invention comprises the backlight described above. A liquid crystal display device according to the present invention may perform the step in turning off the power supply of the liquid crystal display device. By doing this, the above step will not be noticed visually by users.

Moreover, a liquid crystal display device according to the present invention may also perform the step in turning on the power supply of the liquid crystal display device. In this case, the liquid crystal display device may comprise a temperature sensor for detecting the temperature in case the temperature in the liquid crystal display device is able to be regarded as uniform in turning on the power supply. By doing this, the driver circuit of each light source module can be controlled based also on the above temperature.

Moreover, in the liquid crystal display device according to the present invention, the step (control for driver circuit of each light source module) may be performed after the power supply of the liquid crystal display device is turned on.

Moreover, in the present liquid crystal display devise, it is preferable that the predetermined condition (for instance: driving current value) is set so that users will not notice the step.

Moreover, in the present liquid crystal display devise, it is preferable that the display section is driven in the step so that users will not notice the light from the backlight device visually. For instance, the display section may be provided with a black screen. By doing this, the step can be performed without being noticed by users.

Moreover, the present liquid crystal display devise may be arranged such that the driver circuit of the light source module is controlled based on the light emitting quantity of light emitting element of each light source module, so as to adjust the driving current value or driving frequency of light emitting element in normal display.

Moreover, a method according to the present invention for controlling an illuminating device provided with light source modules each of which has a light emitting element and a driver circuit for driving the light emitting element, comprises: grouping the light source modules into groups including a plurality of the light source modules with intervals therebetween; lighting the each light emitting element of the light source modules in the same group simultaneously under a predetermined condition for all the groups in turn; detecting a light emitting quantity of the light emitting element of each light source module; and controlling the driver circuit for each light source module based on the light emitting quantity of the light emitting element of the light source module. In this case, it is preferable that the intervals between each light source module are so large that the light from each light source module in the same group does not interfere the others.

Moreover, a method according to the present invention for controlling a liquid crystal display device, comprises: controlling a backlight device including light source modules each of which has a light emitting element and a driver circuit for driving the light emitting element, by the control method, wherein: the step of turning is performed in turning on or off the power supply of the liquid crystal display device.

As described above, in accordance with the present illuminating device, because a plurality of light source modules are lit simultaneously, and thereafter the light emitting quantity is detected, time for the detection step can be drastically reduced compared to a step of scanning light source modules (detecting light emitting quantity) one by one. Moreover, because each light source module in the same group (lit simultaneously) is arranged with intervals between each other, a crosstalk between those light source modules is reduced. As a result, the detection accuracy of light emitting quantity can be secured. The driver circuit of the light source module is controlled based on the light emitting quantity of each light source module detected in the step, and thereby the correction of light emitting quantity of each light source module can be performed accurately in a short time. BRIEF DESCRIPTION OF DRAWINGS

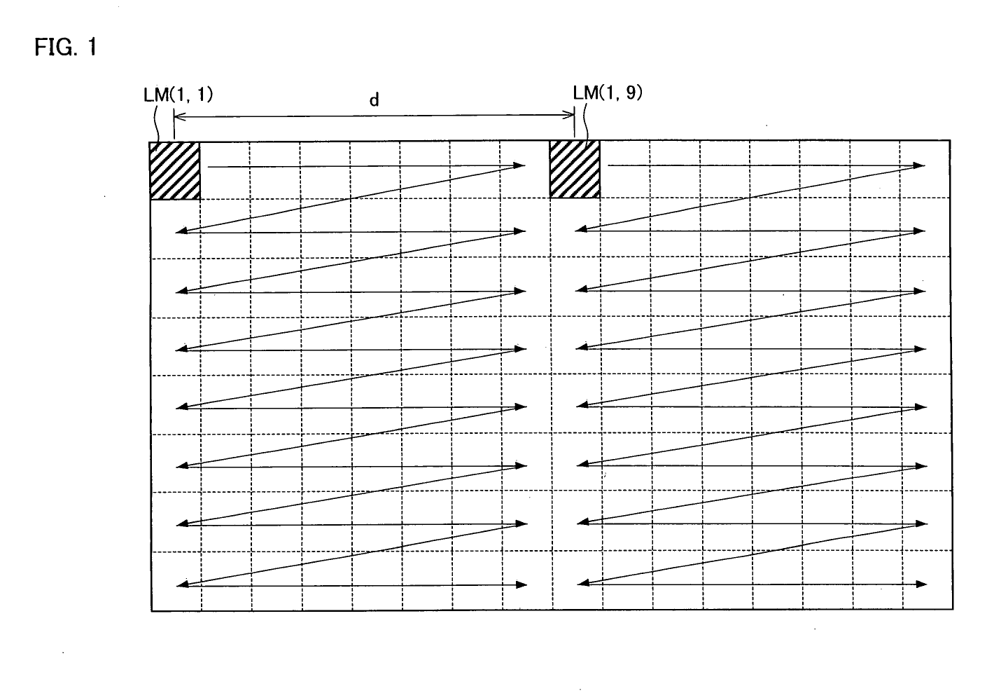

FIG. 1 is a schematic view showing an example of detection order of each group (a group containing a plurality of light source modules).

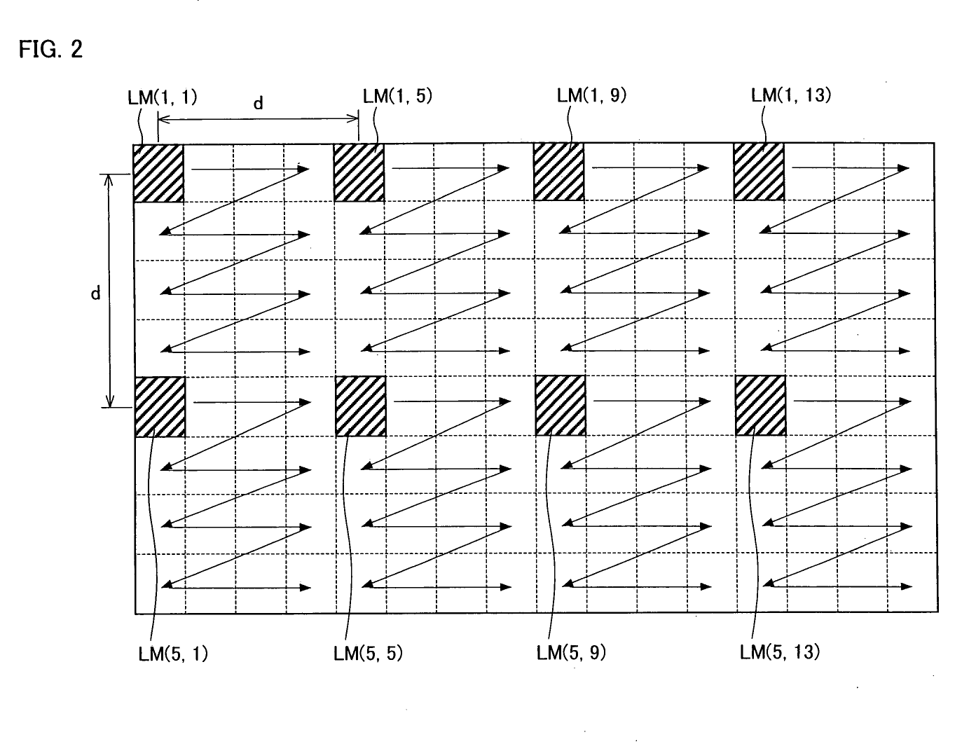

FIG. 2 is a schematic view showing an example of detection order of each group (a group containing a plurality of light source modules).

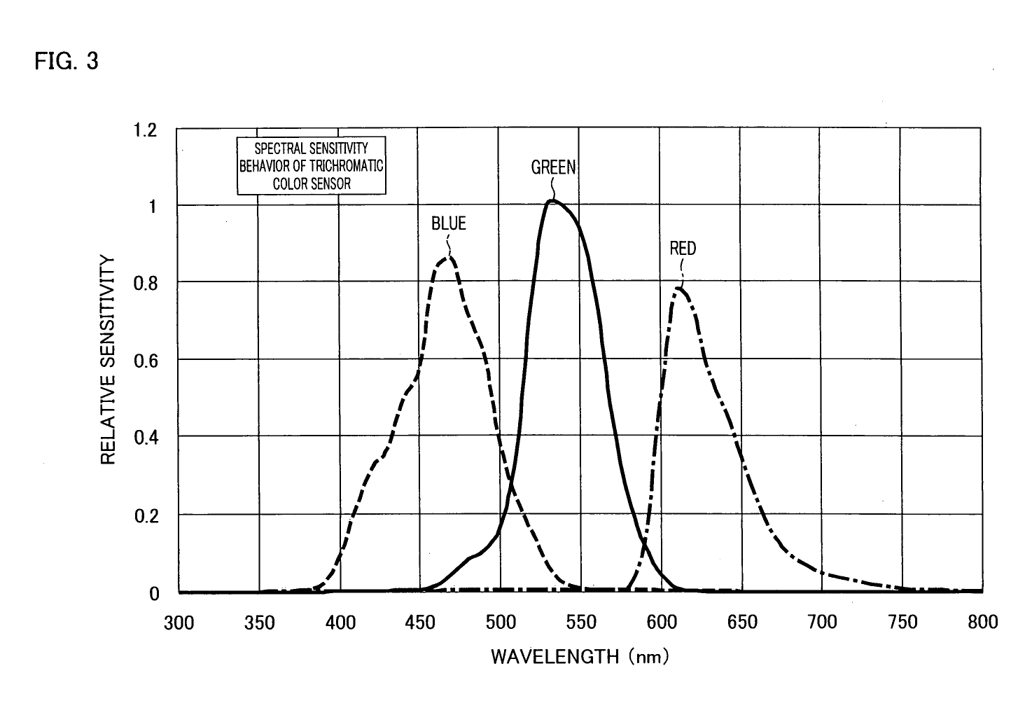

FIG. 3 is a graph showing a sensitivity behavior of a color sensor of light source module.

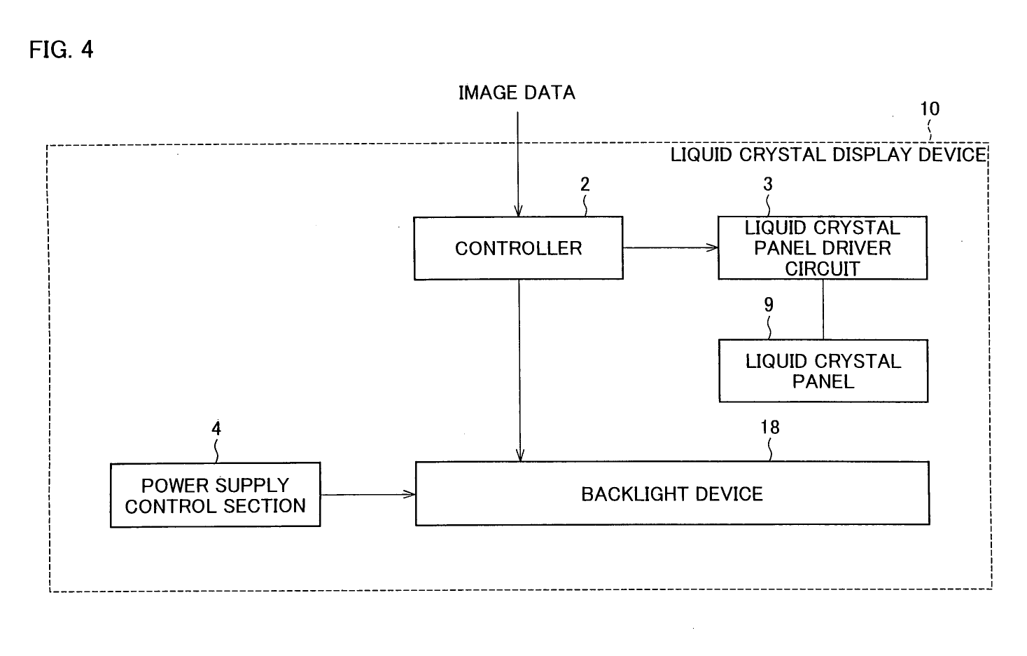

FIG. 4 is a block diagram showing a configuration of the present liquid crystal display device.

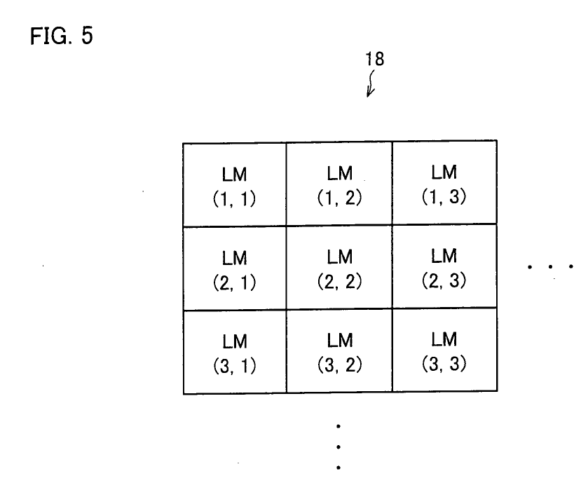

FIG. 5 is a schematic view showing a configuration of the backlight device of the liquid crystal display device in FIG. 4.

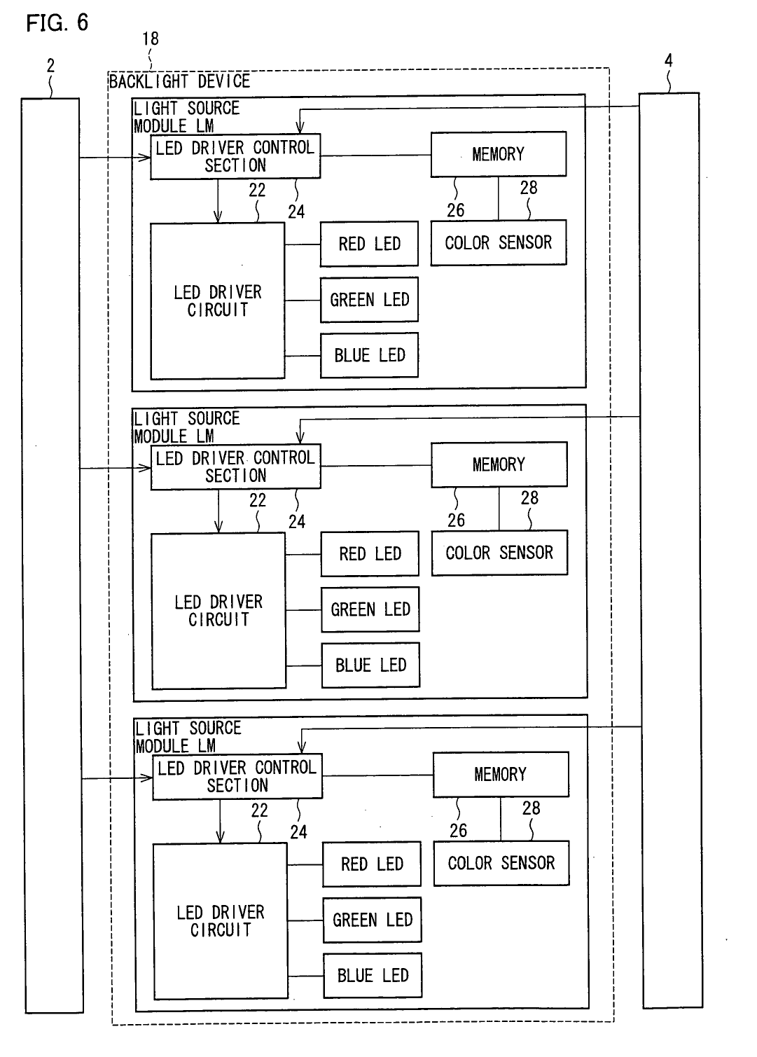

FIG. 6 is a block diagram showing control relations of backlight device and the configuration of light source module.

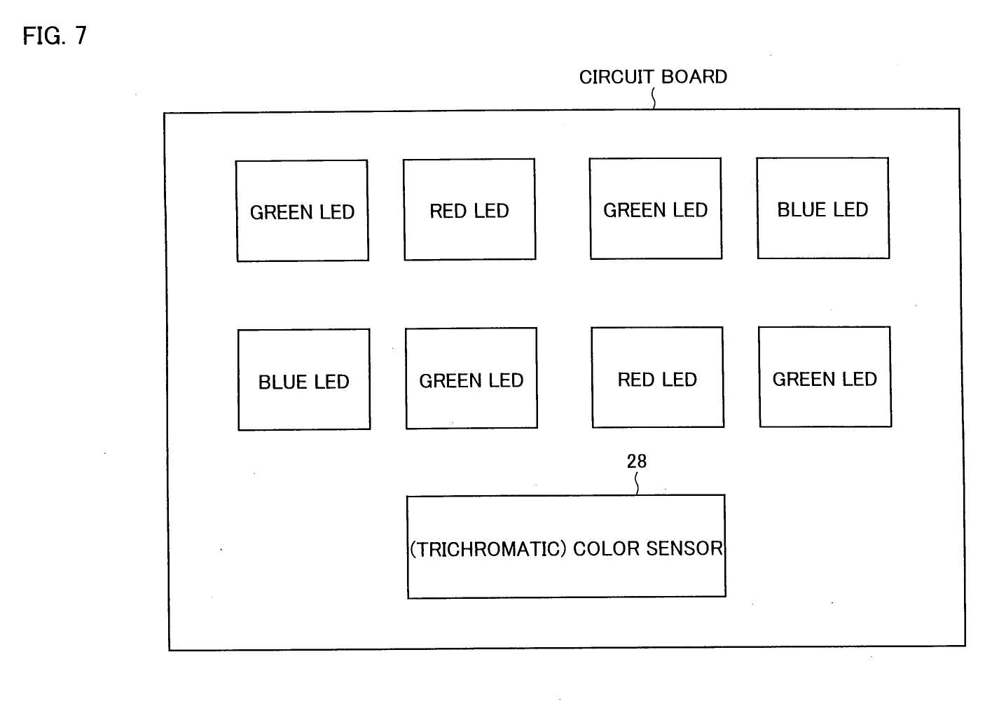

FIG. 7 is a schematic plan view showing an example of arrangement of each color LED and a color sensor.

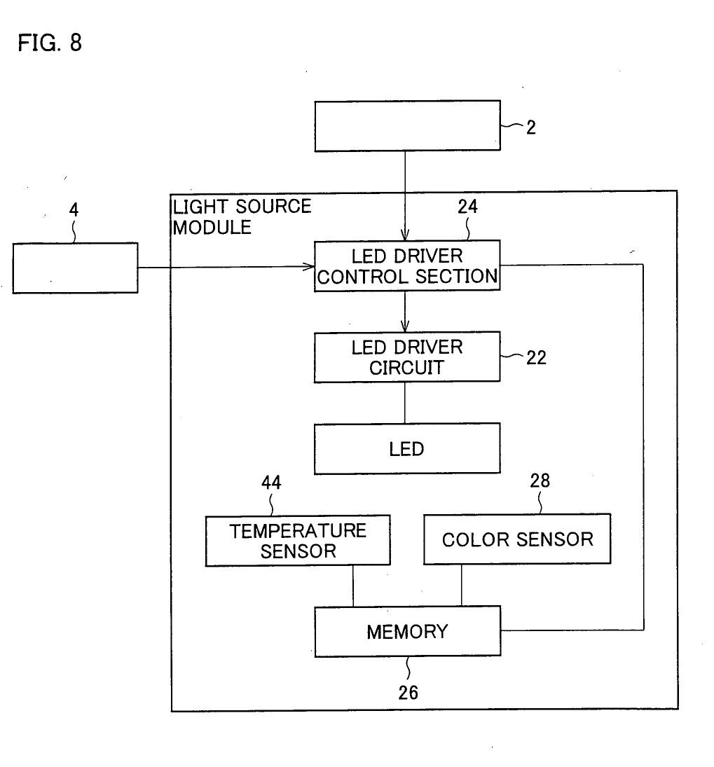

FIG. 8 is a block diagram showing a configuration other than the backlight device.

### EXPLANATION OF REFERENTIAL NUMERALS

2: Controller
3: Liquid crystal panel driver circuit
4: Power supply control section
9: Liquid crystal panel
10: Liquid crystal display device
18: Backlight device
22: LED driver circuit
24: LED driver control section
26: Memory
44: Temperature sensor
LM: Light source module

### BEST MODE FOR CARRYING OUT THE INVENTION

Embodiments of the present invention are described below with reference to FIGS. 1 to 8. As shown in FIG. 4, an embodiment of a liquid crystal display device 10 is provided with a liquid crystal panel 9, a liquid crystal panel driver circuit 3, a controller 2, a present backlight device 18, a light element such as diffusion panel (not illustrated), and a power supply control section 4. The controller 2 controls the liquid crystal panel driver circuit 3 and the backlight device 18 based on inputted image data. Under the control by the controller 2, liquid crystal panel driver circuit 3 drives the liquid crystal panel 9. The backlight device 18 emits light following the control by the controller 2. The light emitted from the backlight device 18 is supplied to the liquid crystal panel 9 through such as a diffusion panel (not illustrated). Moreover, the power supply control section 4 controls the power supply system of the liquid crystal display device 10 according to whether the power supply is turned on or off by a user.

The backlight device 18 is provided with a plurality of light source modules LM (I, j) (note: i=1, 2, . . . j=1, 2, . . . ) as shown in FIG. 5 for instance. A part of the backlight device 18 (the part containing three light source modules) is shown in FIG. 6. As shown in FIG. 6, each light source module LM is provided with one or more red LEDs, one or more green LEDs, one or more blue LEDs, a LED driver circuit 22, a LED driver control section 24, a memory 26 provided with analog/digital conversion circuit, and a color sensor 28. The memory 26 may be contained in the LED driver control section 24 or the controller 2.

The LED driver control section 24 controls the LED driver circuit 22 based on commands from the controller 2. The LED driver circuit 22 drives (lights) the red, green, and blue LEDs individually based on the control of the LED driver control section 24.

The color sensor 28 detects each light emitting quantity of the red, green, and blue LEDs, and thereafter the detected result is outputted to the analog/digital conversion circuit of the memory 26. The detected result converted in digital data is then stored in the memory 26. Moreover, the LED driver control section 24 controls the LED driver circuit 22 based on the result in the memory 26, and thereby the light emitting quantity of each color LED is corrected. In accordance with the present backlight device 18, the control for the LED driver circuit 22 based on the detected result of light emitting quantity of each color LED is performed for all the light source modules LM.

FIG. 7 shows a case that each light source module LM is provided with two red LEDs, four green LEDs, two blue LEDs, and a color sensor. It is preferable that each LED and a color sensor of each light source module are provided in the same circuit board as shown in FIG. 7. The present invention is not limited to the configuration of the light source module LM shown in FIG. 7. For instance, each light source module can be provided with only white LEDs.

The color sensor can be arranged anywhere on the circuit board. However, it is preferable that the sensor is arranged so as not to be influenced so much by light (outside light) other than the light of each LED of light source module. This configuration reduces detection error. Moreover, the three colors of light (red, green, blue) of each LED are mixed by a mixing element, and thereafter the mixed light illuminates the liquid crystal panel 9 through a light element such as diffusion panel (not illustrated).

A detection step for the light emitting quantity of each light source module is described in more details below.

The present detection step can be performed when the LED is at service temperature. For instance, the detection step is performed in turning off the power supply of the liquid crystal display device 10 by a user. By doing this, the present detection step will not be noticed visually by users.

Moreover, in the present detection step, each color LED (plural number) emits light under the predetermined condition (driving current value), and thereafter the light emitting quantity is detected. To be more precise, the LED driver control section 24 controls the LED driver circuit 22 by the command from the power supply control section 4 recognizing the power-off, and thereafter each color LED of light source module is lit. It is preferable that the above driving current value for each color LED is set to emit weak light so that the light will not be noticed by users. Moreover, in the detection step, the liquid crystal panel driver circuit 3 that receives a command from the controller 2 may drive the liquid crystal panel 9 so that the light from the backlight device 18 will not be noticed by users. For instance, the liquid crystal panel 9 is provided with a black screen, and thereby the detection step is not noticed by users, and also an influence of outside light can be eliminated.

In accordance with the present liquid crystal display device 10, the detection step is performed for a plurality of light source modules simultaneously. For instance, as shown in FIG. 1, a plurality of light source modules (shaded light source modules in the figure) those are separated by a distance d (distance between light source modules enough not to be influenced by the other light emitting) are grouped. All light source modules LM (I, j) (note: i=1, 2, . . . j=1, 2, . . . ) are distributed in any one of the groups. That is, light source module LM (1, 1) and light source module LM (1, 9) are grouped, LM (2, 1) and LM (2, 9) are grouped, LM (3, 1) and LM (3, 9) are grouped, and continued similarly (that is, LM (i, 1) and (i, 9) are grouped). Moreover, light source module LM (1, 8) and light source module LM (1, 16) are grouped, LM (2, 8) and LM (2, 16) are grouped, LM (3, 8) and LM (3, 16) are grouped, and continued similarly (that is, LM (i, 8) and (i, 16) are grouped). As just described, two light source modules LM (i, j) and (i, j+8) are grouped.

Moreover, each light source module in the same group performs the detection step simultaneously. The two red LEDs, four green LEDs, and two blue LEDs emit light with predetermined driving current value in turn, and thereafter the light quantity (of the three colors) is detected by the color sensor 28. The detected result is outputted to the analog/digital conversion circuit of the memory 26. The above driving current value is within a range that the light emitting quantity of each LED is not noticed by the user. The step is performed in all the groups following the zigzag arrows in FIG. 1 (The group of LM (1, 1) and LM (1, 9)→the group of LM (1, 8) and LM (1, 16) the group of LM (2, 1) and LM (2, 9)→the group of LM (2, 8) and LM (2, 16), ), and thereby the light emitting quantity of each color of all light source module LM (i, j) (note: i=1, 2, . . . j=1, 2, . . . ) can be stored in the memory 26 as digital data. By doing this, the detection step time can be reduced to half compared to a case of scanning (detecting) the light source modules one by one. Moreover, each light source module in the same group (lit simultaneously) is arranged with intervals between each other by the distance d (distance between light source modules enough not to be influenced by the other light emitting), and thereby the detection accuracy of the light emitting quantity of each color LED can be secured.

After the above detection step, when the liquid crystal display device operates normally, the LED driver control section 24 controls the LED driver circuit 22 based on the light emitting quantity read out from the memory 26 in each light source module LM. To be more precise, the LED driver control section 24 compares the light emitting quantity of each LED with the standard values of the colors. When the light emitting quantity is smaller than the standard value, the LED driver control section 24 controls the LED driver circuit 22 to increase the light emitting quantity of the color of LED. When the light emitting quantity is larger than the standard value, the LED driver control section 24 controls the LED driver circuit 22 to reduce the light emitting quantity of the color of LED. This control is performed for all the light source modules, and thereby a difference of light emitting quantity between the same color LEDs is reduced drastically. Examples of a method for correcting the light emitting quantity of LEDs encompass adjusting the driving current value of the LED driver circuit 22, or adjusting the light emitting time (driving frequency) of LED per unit time without changing the current value.

The standard value of light emitting quantity of each color can be predetermined. However, this may causes that the correction of light emitting quantity can not be performed accurately because the temperatures of light emitting element of light source modules are different depending on the latest use (illuminating) situation when the detection step is performed at the same time as the power supply of the liquid crystal display device is turned off (in the light emitting bodies are at their service temperature).

Especially, when the detection step is performed with the light emitting bodies at their service temperature, it is preferable that a temperature sensor 44 is provided in each light source module as shown in FIG. 8, and the temperature is measured at the same time as detecting the light emitting quantity of each color LED of each light source module. In this case, the standard value of light emitting quantity of each color LED is set for each temperature.

More specifically, the detected light emitting quantity of each color LED by the detecting step and the measured temperature of temperature sensor 44 are stored in the memory 26 of each light source module. The LED driver control section 24 controlled by the power supply control section 4 compares the light emitting quantity of each color LED with the standard value corresponding to the measured temperature of the color. The LED driver control section 24 controls the LED driver circuit 22 based on the comparison result (change quantity of light emitting quantity by such as secular variation).

For instance, on the condition that a standard light emitting quantity of red LED is regarded as Lx at a temperature T1 and a standard light emitting quantity of red LED is regarded as Ly at a temperature T2, if the detected temperature of light source module LM (1,1) is T1 with the light emitting quantity of red LED L1, the LED driver control section 24 controls the LED driver circuit 22 (corrects the light emitting quantity) based on the change quantity of light emitting quantity (L1-Lx) in the red LED of light source module LM (1, 1). Moreover, if the detected temperature of light source module LM (3, 3) is T2 with the light emitting quantity of red LED L2, the LED driver control section 24 controls the LED driver circuit 22 (corrects the light emitting quantity) based on the change quantity of light emitting quantity (L2-Ly) in the red LED of light source module LM (3, 3). By doing this, even though the detection step is performed with the light emitting bodies at their service temperature (each light source module has temperature distribution), the light emitting quantity of each light source module can be corrected accurately.

Moreover, in FIG. 1, a scanning (detection of light emitting quantity) order for each group (a group containing a plurality of light source modules) is indicated by zigzag arrows. This order is indicated just for an example. Any pattern of scan order for each group is permissible because the light source modules of each group are arranged with intervals enough not to influence each other by their light.

Moreover, in FIG. 1, two light source modules are grouped and each light source module in the same group is detected simultaneously. However, the present invention is not limited to this configuration. For instance, as shown in FIG. 2, eight light source modules can be grouped and the eight light source modules in the same group may be detected simultaneously. Following the zigzag arrows in FIG. 2, the detection step is performed in the order like: a group of LM (1, 1), LM (1, 5), LM (1,9), LM (1, 13), LM (5, 1), LM (5, 5), LM (5, 9), and LM (5, 13)→a group of LM (1, 4), LM (1, 8), LM (1, 12), LM (1, 16), LM (5, 4), LM (5, 8), LM (5, 12), and LM (5, 16)→a group of LM (2, 1), LM (2, 5), LM (2, 9), LM (2, 13), LM (6, 1), LM (6, 5), LM (6, 9), and LM (6, 13) and so forth. By doing this, the detection step time can be reduced to an eighth compared to scanning (detecting) the light source modules one by one. In this case also, each light source module in the same group (lit simultaneously) are arranged with intervals between each other by the distance d (distance between light source modules enough not to be influenced by the other light emitting), and thereby the detection accuracy of the light emitting quantity of each color LED can be secured.

Moreover, the detection step may be performed in user's turning on the power supply of the liquid crystal display device 10. More specifically, the control section for LED 24 controls the LED driver circuit 22 by the command from the power supply control section 4 recognizing power-on, and thereafter each color LED of light source module is lit. In this case, it is preferable that the above driving current value for each color LED is set to emit weak light so that the light will not be noticed by users. Moreover, in the detection step, the liquid crystal panel driver circuit 3 controlled by the controller 2 may drive the liquid crystal panel 9 so that the light from the backlight device 18 will not be noticed by users. For instance, the liquid crystal panel 9 is provided with a black screen, and thereby the detection step is not noticed by users, and also an influence of outside light can be eliminated.

When the power supply of the liquid crystal display device is turned on, it is often occurred that the entire liquid crystal display device including each light source module is at an even temperature (for instance: room temperature) because certain degree of time has passed since the power supply is turned off.

In this case, for instance, a temperature sensor for the liquid crystal display device is provided, and if the detected temperature by the sensor is regarded as the temperature of each light source module, there is no need that a temperature sensor is provided in each light source module. However, it may happen that the temperature of each light source device is not even because the interval between the power-off and the power-on is short. In this case, for instance, it may be arranged such that a timer function is provided in the controller 2, and only when the interval between the power-off and the power-on is longer than or equal to a predetermined time, the detection step is performed. The detection step should be finished before the temperature of each light source module become uneven after the power-on. In accordance with the present embodiment, the detection step can be finished in a short time (the temperature of each light source module is still even) after the power-on (note: the temperatures of each light source module become different after a period of time has passed after the power-on). Thus, the present embodiment allows the detection step to be finished before the temperature of each light source module become uneven after the power-on.

Alternatively, a temperature sensor may be provided in each spot of large and small temperature increase in the liquid crystal display device. In this arrangement, only when almost even temperatures are detected by the two temperature sensors, the detection step is performed, and thereafter the detected temperature may be regarded as the temperature of each light source module. With this arrangement, a temperature sensor is not needed to be provided in each light source module.

Moreover, in the detection step performed under powered-on condition, when the liquid crystal display device performs normal operation after the detection step, the LED driver control section 24 controls the LED driver circuit 22 based on the light emitting quantity read out from the memory 26 in each light source module LM.

In the above each configuration, in accordance with the light source modules in the same group, the two red LEDs, four green LEDs, and two blue LEDs are lit in turn at the same timing with a predetermined driving current value. In this case, a low-cost monochromatic sensor can be provided instead of the color sensor 28 shown in FIG. 7 and FIG. 8.

The present invention is not limited to the above configuration (each color LED of each light source module is lit in turn). For instance, in the light source modules in the same group, the two red LEDs and the four blue LEDs may be lit simultaneously, and thereafter the two green LEDs may be lit. That is, in each light source module, the two red LEDs and the four blue LEDs are lit simultaneously with their predetermined driving current value, and thereafter the light emitting quantity of each color LED (red and blue) is simultaneously detected by the trichromatic color sensor 28. After that, the two green LEDs are lit with their predetermined current value, and thereafter the light emitting quantity of the green LED is detected by the trichromatic color sensor 28. In accordance with the sensitivity behavior of color sensor shown in FIG. 3, even though the light emitting quantity of each LED (red and blue) is detected simultaneously, there is no (or small) influence of crosstalk because the peaks of red and blue wavelengths are separated one another. Moreover, the peak of green wavelength is near to the peaks of red and blue wavelengths. Therefore, another detection step for the green LED (other than for the red and blue LEDs) is performed to avoid the crosstalk. By doing this, the detection step time for one light source module can be reduced to two-thirds compared to the case that red, green, and blue LEDs of each light source module are lit in turn.

In accordance with the backlight device 18, the light emitting quantity of each color LED of all the light source modules can be detected and corrected in a short time without being noticed by the user. The evenness of color and brightness of all the light source modules can be improved thereby.

The invention being thus described, it will be obvious that the same way may be varied in many ways. Such variations are not to be regarded as a departure from the spirit and scope of the invention, and all such modifications as would be obvious to one skilled in the art are intended to be included within the scope of the following claims.

### INDUSTRIAL APPLICABILITY

The present illuminating device is suitable for use in a backlight provided in such as a liquid crystal display and a liquid crystal display television.

1. An illuminating device comprising:
light source modules each including a light emitting element and a driver circuit for driving the light emitting element, the driver circuit of each light source module being controllable individually, wherein:
the light source modules are grouped into groups including a plurality of the light source modules arranged with intervals between each other;
the step of turning on the each light emitting element of the light source modules in the same group simultaneously under a predetermined condition is carried out in turn for all the groups; and
the driver circuit for the light source module is controlled based on a light emitting quantity thus obtained of. the light emitting element of each light source module.

2. The illuminating device according to claim 1, wherein the intervals between each light source module are so large that the light from each light source module in the same group does not interfere the others.

3. The illuminating device according to claim 1, wherein each light source module includes a light sensor for detecting the light emitting quantity of the light emitting element included in the light source module.

4. The illuminating device according to claim 1, wherein the step is performed when the light emitting element is at its service temperature.

5. The illuminating device according to claim 1, wherein each of the light source module includes a temperature sensor.

6. The illuminating device according to claim 5, wherein a change quantity of light emitting quantity is calculated in each of the light source module based on the light emitting quantity of light emitting element obtained in the step and the temperature detected by the temperature sensor during the step, and the driver circuit is controlled based on the change quantity of light emitting quantity.

7. The illuminating device according to claim 1, wherein each light source module includes light emitting elements of plural colors, and the same-colored light emitting elements can be lit simultaneously in each light source module in the same group.

8. The illuminating device according to claim 7, wherein each light source module includes LEDs of three colors, and in each light source module, each color LED is lit in turn.

9. The illuminating device according to claim 7, wherein each light source module includes LEDs of three colors, and in each of the light source module, the two colors of LEDs are lit simultaneously, and the rest color of the LED is lit thereafter.

10. The illuminating device according to claim 9, wherein each light source module includes the red LED, green LED and blue LED, the red and blue LEDs are lit simultaneously, and the green LED is lit thereafter.

11. The illuminating device according to claim 1, wherein the condition is a driving condition for the light emitting element.

12. The illuminating device according to claim 1, wherein the driver circuit of each light source module is controlled based on the light emitting quantity of the light emitting element of the light source module, so as to adjust a driving current value or driving frequency of the light emitting element.

13. A backlight device comprising:
an illuminating device according to claim 1.

14. A liquid crystal display device comprising:
a backlight device according to claim 13.

15. The liquid crystal display device according to claim 14, wherein the step is performed in turning off the power supply of the liquid crystal display device.

16. The liquid crystal display device according to claim 14, wherein the step is performed in turning on the power supply of the liquid crystal display device.

17. The liquid crystal display device according to claim 14, wherein the step is performed after the power supply of the liquid crystal display device is turned on.

18. The liquid crystal display device according to claim 14, wherein the predetermined condition is set so that users will not notice the step.

19. The liquid crystal display device according to claim 14, wherein the display section is driven in the step so that users will not notice the light from the backlight device visually.

20. The liquid crystal display device according to claim 16, further comprising a temperature sensor for detecting the temperature in case the temperature in the liquid crystal display device is able to be regarded as uniform in turning on the power supply.

21. The liquid crystal display device according to claim 14, wherein the driver circuit of the light source module is controlled based on the light emitting quantity of light emitting element of each light source module, so as to adjust the driving current value or driving frequency of light emitting element in normal display.

22. A method for controlling an illuminating device provided with light source modules each of which has a light emitting element and a driver circuit for driving the light emitting element, comprising:
grouping the light source modules into groups including a plurality of the light source modules with intervals therebetween;
lighting the each light emitting element of the light source modules in the same group simultaneously under a predetermined condition for all the groups in turn;
detecting a light emitting quantity of the light emitting element of each light source module; and
controlling the driver circuit for each light source module based on the light emitting quantity of the light emitting element of the light source module.

23. The method according to claim 22, wherein the intervals between each light source modules are so large that the light from each light source module in the same group does not interfere the others.

24. A method for controlling a liquid crystal display device, comprising:
controlling a backlight device including light source modules each of which has a light emitting element and a driver circuit for driving the light emitting element, by a control method according to claim 22;
wherein the step of turning is performed in turning on or off the power supply of the liquid crystal display device.
